(19) United States
(12) Patent Application Publication
(10) Pub. No.: US 2026/0225051 A1
(43) Pub. Date: Aug. 6, 2026

(54) LIQUID DISPERSION PREPARATION PROCESSES

(71) Applicant: DSM IP ASSETS B.V., Maastricht (NL)

(72) Inventors: Bernd SCHLEGEL, Kaiseraugst (CH); Markus NOWOTNY, Kaiseraugst (CH)

(21) Appl. No.: 19/148,172

(22) PCT Filed: Jan. 17, 2024
(86) PCT No.: PCT/EP2024/051045

§ 371 Date: Jul. 15, 2025

Related U.S. Application Data
(60) Provisional application No. 63/480,246, filed on Jan. 17, 2023.

(51) Int. Cl. B01F 23/41; B01F 23/45; B01F 23/70; B01F 23/80; B01F 25/51; B01F 101/06

(52) U.S. Cl. CPC B01F 23/413; B01F 23/4146; B01F 23/45; B01F 23/708; B01F 23/804; B01F 25/51; B01F 2101/06

(57) ABSTRACT

Some aspects of the disclosure relate to processes for preparing liquid dispersions, which may comprise directing a pre-dispersion with a liquid and an oily phase through one or more filtration elements (104), and/or filtering an aqueous solution of the hydrocolloids before preparation of the pre-dispersion, and pumping the pre-dispersion into a turbulence chamber (102) and ejecting a liquid dispersion from the turbulence chamber (102) with the dispersed liquid phase having an average size of 50-220 nm, where the residence time of the pre-dispersion in the turbulence chamber (102) for each of the one or more passes through the turbulence chamber (102) is less than 10⁻⁶ seconds.

### CROSS REFERENCE TO RELATED APPLICATION

This application claims the priority benefit of U.S. Provisional Application No. 63/480,246, filed Jan. 17, 2023, and entitled “Liquid Dispersion Preparation Processes.” This application is hereby incorporated herein by reference in its entirety.

### TECHNICAL FIELD

In some aspects, this disclosure relates to improved methods of preparing liquid dispersions, solid powders prepared from dispersions, or consumable products such as beverages incorporating the dispersed and/or powdered material.

### BACKGROUND

Processes for preparing fine dispersions have relied on extended residence times in mixing environments to provide sufficient agitation of the dispersed material. These processes have various disadvantages, in particular that longer time periods are required for preparation, lowering total throughput of the dispersion production process and increasing wear on equipment in the overall preparation processes. Longer run times also require more energy expenditure and may result in undesirable damage to the dispersed phase during processing in addition to dispersing it. Thus, new processes for preparing dispersions are needed.

### SUMMARY

This Summary provides an introduction to some general concepts relating to this disclosure in a simplified form, where the general concepts are further described below in the Detailed Description. This Summary is not intended to identify key features or essential features of the disclosure.

In some aspects, this disclosure relates to processes of, inter alia, preparing a dispersion. In some examples, the process comprises the steps of providing a pre-dispersion into a fluid chamber of a mixing device, the pre-dispersion comprising a liquid phase and an oily phase. Then, in since examples, the process includes optionally directing the pre-dispersion from the fluid chamber through one or more filtration elements which capture at least some of the solid pre-dispersion particles to yield a filtered pre-dispersion. In certain embodiments of the process, the process includes pumping or otherwise transferring the pre-dispersion (pre-filtered or not) into a turbulence chamber through an inlet nozzle in fluid communication through the turbulence chamber, and then ejecting the pre-dispersion from the turbulence chamber through an outlet nozzle in fluid communication therewith after the one or more passes through the turbulence chamber to yield a liquid dispersion.

In some examples, the process includes pumping the pre-dispersion (optionally filtered or not) one or more times into a turbulence chamber through an inlet nozzle in fluid communication therewith, through the turbulence chamber, and out of the turbulence chamber through an outlet nozzle in fluid communication therewith, to complete one or more passes through the inlet nozzle, turbulence chamber, and outlet nozzle, and then the liquid dispersion formed from the pre-dispersion during the one or more passes through the inlet nozzle, turbulence chamber, and outlet nozzle is collected.

The liquid dispersion formed after the one or more passes (e.g. less than three passes) in some examples will have a dispersed phase having an average particle size of about 60 nm to about 210 nm in diameter, or about 50 nm to about 220 nm in diameter, e.g. about 80 to about 140 nm, about 70 to about 140 nm, about 80 to about 120 nm, about 100 to about 120 nm, about 125 nm or less, 120 nm or less, or about 100 nm or less. In certain embodiments, the residence time of the filtered pre-dispersion in the turbulence chamber for each of the one or more passes through the turbulence chamber is less than about 10⁻⁶ seconds.

In certain embodiments, the volume flow rate of the liquid dispersion is greater than about 1,000cm³/sec. In some examples of the process, the liquid dispersion has a turbidity of about 50 Nephelometric Turbidity Units (NTU) or less, or 30 NTU or less. In certain embodiments, the filtered pre-dispersion is at a temperature of 20° C. to 250° C., preferably 20° C. to 80° C. or 40° C. to 80° C., and at a pressure of 100 bar to 3,000 bar, preferably 600 bar to 1,400 bar, when entering the turbulence chamber. In some examples, the pressure of the pre-dispersion inside the turbulence chamber is 600 bar or more, or about 700 bar or more. In some examples, the pre-dispersion is a crude emulsion, and the oily phase may have an average particle size of about 1500 nm or less. In some examples, the oily phase of the pre-dispersion has an average particle size of about 200 nm to about 5000 nm, or about 700 nm to about 1500 nm.

In certain examples, the process comprises generating the pre-dispersion through the application of one of more impact forces, shear forces, or cavitation forces, or a combination thereof, e.g. through the use of a rotor stator system or a high pressure homogenizer.

In some examples, a pressure of the pre-dispersion inside the turbulence chamber is about 600 bar or more, or about 1,000 bar or more, or about 1,250 bar or more, or about 1,400 bar or more, or about 1,500 bar or more.

In some examples of the process, the pre-dispersion has ten or fewer passes through the turbulence chamber before yielding the liquid dispersion, or five or fewer passes, or four or fewer passes, or three or fewer passes. In various examples of the process, the pre-dispersion has four or fewer passes through the inlet nozzle, turbulence chamber, and outlet nozzle before yielding the liquid dispersion, or three or fewer passes, or two or fewer passes.

In certain embodiments of the process, the residence time of the pre-dispersion during each pass through the turbulence chamber is between about 10⁻¹⁰ and 10⁻⁶ seconds, or between about 10⁻⁹ and 10⁻⁶ seconds, preferably between about 10⁻⁸ and 10⁻⁷ seconds or between 1×10⁻⁸ and 5×10⁻⁸ seconds. In some examples of the process, the volume flow rate of the liquid dispersion (e.g., traveling through and/or exiting the turbulence chamber) is between about 500 cm³/sec to 2,500 cm³/sec, and preferably is about between about 1,000 cm³/sec to 1,200 cm³/sec.

In certain examples of the process, the inlet nozzle plate and the outlet nozzle plate each have an external diameter of about 100 mm to about 25 mm, preferably about 150 mm to about 200 mm. In certain embodiments, the outlet nozzle comprises an aperture, wherein the aperture of the outlet nozzle is about 0.05 mm to about 1.5 mm. In some examples, the bore aperture of the inlet nozzle is smaller than the bore aperture of the outlet nozzle. In certain examples, the bores of the inlet nozzles and the outlet nozzles are round, rectangular and/or elliptical. In the case of bores or apertures as described herein having a circular cross-section, the associated dimensions given refer to cross-sectional diameters. In the case of bores or apertures as described herein having other cross-sectional shapes, the associated dimensions refer to diameters of the smallest circle that circumscribes such shapes. In various embodiments, the inlet nozzles and outlet nozzles may comprise, or may consist of, sapphire, diamond, Stainless Steel, ceramic, Silicon carbide, tungsten carbide, or Zirconium oxide, or combinations thereof.

In some examples of the process, the bores of the inlet nozzles and the outlet nozzles are axially spaced apart relative to one another, i.e., they do not share a common axis. In certain embodiments, the length to aperture ratio of the inlet and out bores are from about 5 to about 50 or from about 10 to about 40.

In some examples of the process, at least one filtration element comprises pores with a pore size of about 50 μm to about 200 μm, preferably about 80 μm to about 150 μm.

In some embodiments of the process, the D50 particle size distribution of the dispersed phase of the liquid dispersion is about 50 nm to about 200 nm, or about 70 nm to about 120 nm. In various examples, the liquid dispersion comprises an aqueous solution of a fat soluble vitamin and a matrix material. In certain embodiments, the fat-soluble vitamin comprises Vitamin A, Vitamin E, Vitamin K, Vitamin D, or any derivative or combination thereof.

In certain examples of the process, the matrix material comprises a lignosulfonate, starch hydrolysate, starch, or modified food starch, gelatin or combinations thereof. In some examples the liquid dispersion further comprises inorganic nano-and/or microparticles, preferably wherein the inorganic nano-and/or micro-particles comprise, consist essentially of, or consist of silica.

In some examples of the process, the process further comprises combining the liquid dispersion with one or more liquids to provide a liquid beverage. In some examples, the process includes drying the liquid dispersion to provide a powder. In certain embodiments, the process further comprises combining the powder with one or more liquids to provide a liquid beverage.

These and other features, advantages, and objects of the present disclosure will be further understood and appreciated by those skilled in the art by reference to the following specification, claims, and appended drawings.

### BRIEF DESCRIPTION OF THE DRAWINGS

Example embodiments of the disclosure will now be described by way of example only and with reference to the accompanying drawings, in which:

FIG. 1 provides an example mixing device with turbulence chamber that may perform embodiments of the processes of this disclosure.

### DETAILED DESCRIPTION

The examples, materials and methods of described herein provide, inter alia, processes and systems for preparing liquid dispersions, powders, or beverages (e.g. edible powders from a dried liquid dispersion or aqueous/juice beverages including one or more vitamins and/or vitamin derivatives in the form of a dispersion or a dried powder made from a dispersion). These and other aspects, features and advantages of the disclosure or of certain embodiments of the disclosure will be further understood by those skilled in the art from the following description of example embodiments. In the following description of various examples, reference is made to the accompanying drawings, which form a part hereof. It is to be understood that other modifications may be made from the specifically described methods and systems without departing from the scope of the present disclosure.

It is also to be understood that the specific materials, systems, devices and processes illustrated in the attached drawings, and/or described in the following specification, are simply example embodiments. Hence, specific dimensions and other physical characteristics relating to the embodiments disclosed herein are not to be considered as limiting. Moreover, the figures of this disclosure may represent the scale and/or dimensions according to one or more embodiments, and as such contribute to the teaching of such dimensional scaling. However, the disclosure herein is not limited to the scales, dimensions, proportions, and/or orientations shown in the figures.

Similarly, the materials and processes illustrated in the attached drawings, and described in the following specification, are simply example embodiments of the concepts defined in the appended claims. Hence, specific dimensions and other physical characteristics relating to the embodiments disclosed herein are not to be considered as limiting unless explicitly stated to be so.

In certain aspects, the disclosure to processes of preparing a liquid dispersion. In some examples, the process comprises the steps of providing a pre-dispersion into a fluid chamber of a mixing device, the pre-dispersion comprising a liquid phase and an oily phase. The pre-dispersion may be an emulsion, such as a crude emulsion. For example, the crude emulsion may include one or more fat soluble vitamin(s) (and/or derivate(s) thereof), with one or more polysaccharide(s) and/or modified polysaccharide(s), dissolved in a liquid such as water, e.g. by heating water (e.g. to around 75 degrees Celsius, or higher), adding one or more polysaccharide materials and stirring until dissolved, then cooling the solution and adding one or more vitamin materials.

The crude emulsion oily phase may have an average particle size of 200 nm to 5000 nm, preferably 700 nm to 1500 nm. In some examples, the crude emulsion may have an average particle size of about 1500 nm or less, about 2000 nm or less, about 1250 nm or less, or about 1000 nm or less. The crude emulsion may have an average particle size of about 1000-2000 nm, about 1250-1750 nm, about 1500-2000 nm, or about 1000-1500 nm. The pre-dispersion, e.g. crude emulsion, may have a water content from about 25-70% (by weight), or from about 30-60%, or a water content of about 40% or more (by weight), about 45% or more, about 50% or more, or about 55% or more. In various embodiments, the water content is about 65% or less, or about 60% or less, or about 50% or less. The pre-dispersion may include one or more lipid materials or lipid derivative materials, such as a vitamin or a vitamin containing material. The lipid content of the solids may be about 3% or more (by weight), or about 5% or more, or about 7% or more. In some examples, the lipid content is about 3-10%, or about 5-9%. In various embodiments, the lipid content is about 20% or less, about 15% or less, about 10% or less. Materials that may be present in the pre-dispersion (and/or the dispersion, powder, and/or beverages made from the same) are described in more detail below after example descriptions of the processes of this disclosure.

In some examples, the process includes generating the pre-dispersion. The pre-dispersion may be generated through the application of one of more impact forces, shear forces, cavitation forces, or a combination thereof (e.g. the use of one or more of any of these forces or any combination of the same) on a precursor material, such as a matrix material and optionally other additives (like one or more vitamins or vitamin derivatives) mixed into a solvent such as water. For example, in some embodiments, the pre-dispersion is generated through the use of a rotor stator system, a colloid mill, and/or a high pressure homogenizer that imparts forces on a material to provide a pre-dispersion (e.g. a crude emulsion). As an example, one or more matrix materials and water (and any additives) may be mixed and stirred under heat until the matrix material(s) dissolve, and then the mixture is cooled and, after addition of any other desirable substances (such as a lipid material or vitamin material) is subjected to the one or more forces, e.g. through addition to a colloid mill or other device.

The process can then include directing the pre-dispersion from the fluid chamber through one or more filtration elements to yield a filtered pre-dispersion. The one or more filtration elements may remove at least some of the solid pre-dispersion particles to provide a filtered pre-dispersion, or may remove a majority of the solid particles, essentially all of the solid particles, or all of the solid particles. This can prevent or minimize any extent that the relatively large solid particles may block or impede flow through some or all of the nozzle(s) of the mixing device. This filtration can be done, for example, using filtration materials that will retain any solids having a particle size exceeding a threshold value, including any of the values associated with particle size (or average particle size), as described above, or a larger value. As a representative example, a filter may be used to remove solids from a crude emulsion that are larger than about 1,000 nm, solids that are larger than about 1,500 nm, solids that are larger than about 5,000 nm, solids that are larger than about 1 μm, solids that are larger than about 25 μm, or solids that are larger than about 50 μm. For example, a filter, screen, sift, or straining component may be present in a fluid chamber and/or piping or tubing, and be positioned such that the pre-dispersion must travel though such filtration element(s) (e.g. screen) when being moved through the system performing the process, for example when the pre-dispersion is being transferred to a turbulence chamber via a pump or other method. In some examples, at least one filtration element comprises pores with a pore size of about 50 μm to about 200 μm, preferably about 80 μm to about 150 μm.

The process may include pumping or otherwise transferring the pre-dispersion (which may or may not be filtered) into a turbulence chamber that will reduce the average particle size of the oily phase to provide a dispersed phase of a liquid dispersion. For example, the pre-dispersion may be transferred through an inlet nozzle plate in fluid communication with the turbulence chamber. The pre-dispersion may then be ejected from the turbulence chamber through an outlet nozzle plate in fluid communication with the turbulence chamber, e.g. pumped out of the turbulence chamber, after the one or more passes through the turbulence chamber. Thus, the pre-dispersion may be ejected from the chamber, and return via piping/tubing connected to the outlet nozzle or other components for another pass through the turbulence chamber from the inlet nozzle, before being ejected such that no more passes are performed (which may also occur after a single pass through the turbulence chamber and without any repeated passes) to yield a liquid dispersion, for example being ejected into a collection chamber connected (e.g. via tubing) to the outlet nozzle.

In certain embodiments of the process, the pre-dispersion has ten or fewer passes through the turbulence chamber, e.g. passes through the inlet nozzle, turbulence chamber and outlet nozzle, before yielding the liquid dispersion. In some examples, the pre-dispersion has five or fewer passes through the inlet nozzle, turbulence chamber, and outlet nozzle before yielding the liquid dispersion, while in some examples it has four or fewer passes, preferably three or fewer passes, and more preferably two or fewer passes through the inlet nozzle, turbulence chamber, and outlet nozzle. In some examples only a single pass occurs.

The liquid dispersion formed after the one or more passes (e.g. less than five passes) in some examples will have a dispersed phase having an average particle size of 60 nm to 210 nm in diameter, preferably 80 to 140 nm, and more preferably 100 to 120 nm. In some examples, the average particle size of the dispersed phase is about 125 nm or less, about 120 nm or less, or about 100 nm or less. In certain embodiments, the liquid dispersion formed after the one or more passes (e.g. four passes through the turbulence chamber) will have a dispersed phase having an average particle size of about 175 nm or less, or about 150 nm or less, or about 140 nm or less. In some examples, the dispersed phase has an average particle size of about 80-120 nm, about 80-150 nm, about 50 -150 nm, about 50-200 nm, or about 100-120 nm.

The particle size of the pre-dispersion (e.g. crude emulsion) and the prepared liquid dispersion may be measured by a laser diffraction instrument such as the Malvern Mastersizer II or similar devices that provide nm measurement of dispersions, and the value used here refers to the average (mean) particle size as determined by such a device. Sampling procedures are known in the art and are further provided by the applicable machinery.

Droplet size for D50 or D90 values may be measured by any conventional particle size analyzer. A preferred measuring method is dynamic light scattering/photon correlation spectroscopy, which provides a result in hydrodynamic diameter or cumulative size. An example supplier of such equipment is Beckmann Coulter device Delsa Nano S.

In some examples of the process, the liquid dispersion has a turbidity of about 50 Nephelometric Turbidity Units (NTU) or less, or about 40 NTU or less, or about 30 NTU or less, while in other examples the liquid dispersion has a turbidity of about 25 NTU or less, and in yet others about 20 NTU or less. The turbidity may be determined by ISO (International Organization for Standardization) standard number 7027. Example equipment for this determination is Hach Lange device Turbidimeter 2100 AN. In some examples, the liquid dispersion is optically clear to a visual observer.

In other examples of the process, the liquid dispersion is dried (e.g. through one or more of spray drying, hot air drying, contact drying, infrared drying, freeze-drying, fluidized bed drying, and/or dielectric drying) to provide a powder, and then when the powder is dissolved in water to provide a concentration of 60 ppm, the resulting solution has a turbidity of turbidity of about 50 Nephelometric Turbidity Units or less, or about 40 NTU or less, or about 320 Units or less, or about 25 Units or less, or about 20 NTU or less, determined via the same standard and equipment (or equivalent methods). In some examples, such a solution incorporating the dried powder is optically clear to an observer.

In certain embodiments, the residence time of the pre-dispersion in the turbulence chamber for each of the one or more passes through the turbulence chamber is less than about 10⁻⁶ seconds. In certain embodiments of the process, the residence time of the pre-dispersion during each pass through the turbulence chamber is between about 10⁻¹⁰ and 10⁻⁶ seconds, or between about 10⁻⁹ and 10⁻⁶ seconds, or between about 10⁻⁸ and 10⁻⁷ seconds. In certain examples, the residence time is preferably between 10⁻⁸ and 10⁻⁷ seconds, and more preferably between 1×10⁻⁸ and 5×10⁻⁸ seconds. In some examples, the residence time is between about 1-7'10⁻⁸ seconds, or between about 1-5×10⁻⁸ seconds. In certain examples, the residence time is less than about 10⁻⁷ seconds, or is less than about 5×10⁻⁸ seconds.

It was unexpectedly determined that shorter residence times, e.g. residence times in the turbulence chamber less than about 10⁻⁶ seconds, can surprisingly provide desirably small average particle sizes such as about 200 nm or less, or even 120 nm or less for the dispersed phase of the liquid dispersion, even when a small number of passes through a turbulence chamber (e.g. a chamber designed in the manner described below) are performed. For example, a residence time in the turbulence chamber less than about 10⁻⁶ seconds for a total or four or two or one pass provided surprising desirable small average particle sizes resulting in an optically clear liquid dispersion. Using this process, therefore, can beneficially provide dispersions with small average particle sizes while still having a more efficient, faster preparation process that can facilitate large-scale and/or rapid production despite the traditional difficulties in preparing dispersions with small average particle sizes.

The volume flow rate should be sufficient to provide the short residence times that unexpectedly provide small average particle sizes. In some examples of the process, the volume flow rate of the liquid dispersion is between about 500 cm³/sec to 2,000 cm³/sec, or about 500 cm³/sec to 2,500 cm³/sec, or about 1000 cm³/sec to 200 cm³/sec. In some examples, the flow rate preferably is between about 1,000 cm³/sec to 2,000 cm³/sec. In some examples, the volume flow rate is about 500 cm³/sec or more, about 750 cm³/sec or more, about 1000 cm³/sec or more, about 1250 cm³/sec or more, about 1500 cm³/sec or more, about 1750 cm³/sec or more, or about 2000 cm³/sec or more.

In some examples, a pressure of the pre-dispersion inside the turbulence chamber is about 100 bar to about 3,000 bar (where the bar values are bar(g), i.e. bar gauge values rather than bar absolute values, as measured by typical equipment), and preferably about 600 bar to about 1,400 bar, before the turbulence chamber. In some examples the pressure is about 700 bar or more, or about 800 bar or more, or about 1000 bar or more, or about 1,200 bar or more. In certain embodiments, even higher pressures may be used, such as about 2,000 bar or more, about 3,000 bar or more, or about 4,000 bar or more. In various embodiments, the pressure of the pre-dispersion before the turbulence chamber is about 600-2,500 bar, or about 600-1,500 bar or about 700-2,500 bar, or about 800 to about 2,400 bar.

In some examples of the process, the pre-dispersion has ten or fewer passes through the turbulence chamber before yielding the liquid dispersion, or five or fewer passes, or four or fewer passes, or three or fewer passes, or two or fewer passes. The number of passes used to obtain the desired average particle size of the dispersed phase may shift based on the design of the turbulence chamber, the flow rate, or other values, but in some advantageous embodiments the residence time and the number of passes are both relatively small to provide a surprisingly efficient process, e.g. residence times of about 1-5×10⁻⁸ seconds and a total number of passes that is five or less, e.g. two or one pass.

Various types of pressurized equipment may be used to convert the pre-dispersion into a liquid dispersion with smaller particle sizes. As one representative example, microfluidizer devices may be used, such as models M-210CE/H, M-110ET, M-610-C, and M-140K from Microfluidics International Corporation located in Newton, MA. Multi-piston microfluidizer models may be used, such as two or three piston pump microfluidizers. As another example, high pressure devices can be used, e.g. piston homogenizers, such as models Ariete NS 3015/NS 3030/NS 3037 from GEA Niro Soavi, located in Parma, Italy.

To convert the pre-dispersion into a liquid dispersion with smaller average particle sizes and/or for homogenization/further emulsification, a variety of temperatures may be used. In some examples, room temperature or nearly room temperature (e.g. about 22° C.) may be used, but in other cases elevated temperatures up to about 75° C. or about 80° C. may alternatively be used. In some examples, the pre-dispersion is at a temperature of about 20° C. to about 250° C., preferably about 20° C. to about 80° C. when passing through the turbulence chamber, or when beginning the first pass through the turbulence chamber. Cooling equipment may be used, for example on or adjacent to piping used to transport the pre-dispersion or recirculating pre-dispersion material between passes in the turbulence chamber, or in connection with the turbulence chamber itself in whole or in part. Heat exchangers, water/oil baths, or other temperature control devices may be used.

The design of the turbulence chamber is sized and shaped to provide mixing, mechanical agitation/contact during the pass through the chamber. Once in the turbulence chamber, the liquids can be mixed and then exit the chamber via the bore of the outlet nozzle.

For example, bores of the inlet nozzles and outlet nozzles of the turbulence chamber may be offset or axially spaced apart from each other. As an example, boundary covers may each include a bore for the inlet or outlet of material (e.g. one opposing boundary cover may include an inlet nozzle and a second opposing boundary cover on the other side of the turbulence chamber (or otherwise positioned away from the first boundary cover) may include an outlet nozzle). For a more particular example, the covers may be circular and spaced apart to provide a generally cylindrical turbulence chamber, where the inlet is positioned relative to a central axis of its cover (which is aligned with the central axis of the cylindrical turbulence chamber) at an angle of zero degrees, while the outlet is positioned on relative to corresponding central axis of the opposing cover (which is aligned with the central axis of the cylindrical turbulence chamber) at an angle of 180 degrees (i.e. on the opposite side of the axis), such that the inlets and outlets are not aligned and material from the inlet will contact surfaces on the opposing cover, connecting surfaces between the covers, or other features of the chamber before leaving the chamber through the outlet. In certain examples, the bores of the inlet/outlet “nozzles” are offset, but not offset to the maximum degree possible, i.e. less 180 degrees apart as positioned relative to the chamber central axis. Bores may be similarly partially, or entirely offset, including in non-cylindrical chambers, e.g. by being placed on different sides/areas of the chamber such that some or all material traveling straight out of an inlet nozzle will not enter an outlet nozzle before contacting another surface such as the opposing boundary cover. In some examples, one or each boundary cover comprises multiple bores, i.e. multiple inlet and/or outlet nozzles, which may be partially or entirely misaligned with some or all other opposing bores.

In some examples, the bores of the nozzles are axially spaced apart relative to one another. In various embodiments, the bores of the one or more inlet and outlet nozzles are positioned on opposite sides relative to a central axis of the chamber. Preferably, any inlet nozzle is not aligned with any outlet nozzle, at least in part, to facilitate pre-dispersion contact with surfaces and/or more chaotic movement while flowing through the turbulence chamber. In some examples, no part of any inlet nozzle is aligned with any part of any outlet nozzle, while in others about 90% or more of the area(s) of any inlet nozzles are not aligned with any area(s) of any outlet nozzle, or about 80% or more, or about 70% or more.

In certain embodiments, the length to aperture ratio of the inlet and out bores are from about 5 to about 50 or from about 10 to about 40. In some examples, an inlet nozzle may have a bore diameter of about 0.05-1 mm, about 0.05-0.5 mm, or about 1 mm or less or about 0.5 mm or less. In some examples, the turbulence chamber may have a diameter or distance between opposing walls of about 0.5-20 mm, or about 1-10 mm, or about 2-10 mm, or about 3-8 mm. In some examples, an inlet nozzle may have a bore diameter (e.g. an internal surface diameter of the nozzle) of about 0.05-1.5 mm, about 0.05-0.8 mm, or about 1 mm or less or about 0.5 mm or less. In some examples, the inlet nozzle plate and the outlet nozzle plate each have an external diameter of about 50 mm to about 300 mm, preferably about 70 mm to about 250 mm, or a diameter of about 250 mm or less, or a diameter of about 150 mm to 250 mm.

The bore diameters of the inlet and outlet nozzles may be identical, but in some embodiments, the inlet bore diameter is smaller than the diameter of the outlet nozzle. In some examples, the bore diameter of the outlet nozzle is about 170% the size of the inlet diameter, or between about 140-180% the size of the inlet diameter.

The nozzles may consist or comprise wear resistant materials. For example, the nozzles (or covers providing the nozzles via one or more bores or other components) may be made of or include one or more of sapphire, diamond, stainless steel, ceramic, silicon carbide, tungsten carbide, zirconium, or combinations thereof. Other materials with sufficient strength may also be used alone or with any of the above material(s). In some examples, at least some or all of the bores of the inlet and/or outlet nozzles may be round, rectangular, or some other geometric shape (in terms of cross-section shape),, or may have a consistent shape but changing size, such as a cone-shaped bore (e.g. the bore increases or decreases in size when moving across or through the cover defining the bore exterior but has a consistent cross-sectional shape like a circular shape), or may be irregularly shaped and/or sized (e.g. the bore changes shape and/or size when moving across or through the cover defining the bore exterior) or elliptical.

The following describe example embodiments of equipment that can be used to perform the processes of this disclosure (e.g. the low residence time procedures that are unexpectedly superior to prior art processes). The processes may be performed using a mixing device, which may include one or more inlet nozzles, one or more turbulence chambers and one or more outlet nozzles, with the inlet nozzle(s), turbulence chamber(s) and outlet nozzle(s) being sequenced, for example being pressed in sequence inside a cylindrical support or conduit. The bores of the inlet nozzles are in fluid communication with the bores of the outlet nozzles through the turbulence chamber and the bores of the inlet and outlet nozzles may be axially spaced apart relative to one another.

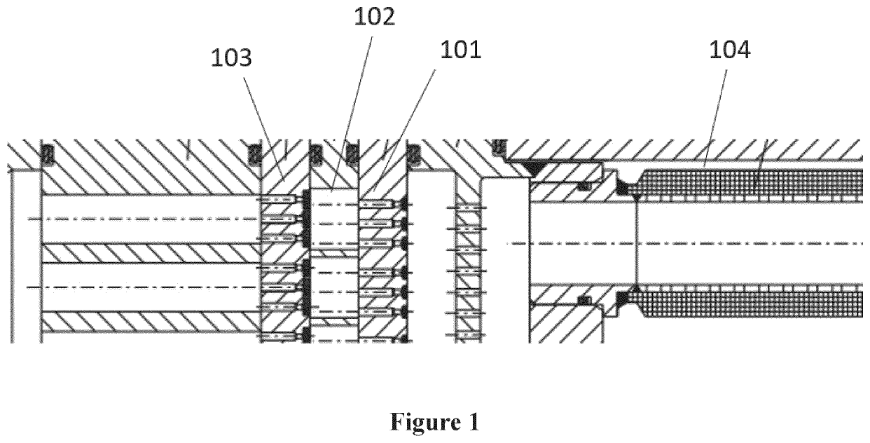

FIG. 1 illustrates a cross-section of an example mixing device including an inlet nozzle plate (101), a turbulence chamber (102) and an outlet nozzle plate (103). Each nozzle plate comprises a plurality of nozzle bores that fluid can flow through, and, as illustrated through the lines demonstrating axes bores, the inlet and outlet nozzle plate bores are axially spaced apart, e.g. off-set from each other. In this and example other embodiments, a distance plate is used to provide the non-nozzle sides of the turbulence chamber and define the distance traveled by the liquid and overall size of the chamber. In this and other example embodiments, there is a filter (104) present prior to the turbulence chamber that is used to provide a filtered pre-dispersion material that may then be routed to the turbulence chamber.

There may be other chambers gaps the liquid travels through at least once prior to reaching the turbulence chamber. In some example, there may be features splitting the chamber and/or any inlet/outlet flows into distinct areas. In some examples, the offset bores may be greater or lesser in number than in this example illustrated embodiment (e.g. there may be a single inlet bore on one side of the chamber, and a single offset outlet bore on the other, or a plurality of bores on one or both sides).

In some examples, the nozzle, e.g. plates, and any material defining the rest of the turbulence chamber are pressed in sequence in a cylindrical support, which may be a bore or bores defined in a surrounding material or other components including a bore. In some embodiments, there are nozzle inserts secured to a support cover positioned in a conduit (i.e. a cylindrical support). The outlet nozzles may be present in an equivalent or similar support cover and the turbulence chamber may be positioned between the opposing covers. In some examples, the nozzles (inlet and/or outlet) may include features that work to block or redirect liquid, promoting agitation and dispersion, where some or all nozzles may have such features.

In some examples, the pre-dispersion travels through one or more inlet nozzles into a turbulence chamber. The chamber may comprise a contact piece(s) positioned in or protruding into the flow of material being pumped through the inlet nozzle into the turbulence chamber, such that the contact piece(s) impart mechanical force onto the pre-dispersion material, in addition to the side(s)/surface(s) of the nozzles and chamber.

In some examples, the turbulence chamber is cylindrical or generally cylindrical, while in others it has more irregular shapes, such as generally “z-shaped” or “y-shaped” areas defined within. In some examples, the turbulence chamber is defined in part by and inlet disc and an outlet disc, each of which comprise one or more bore apertures that are smaller than the bore of the turbulence chamber. The inlet/outlet bores may be aligned, or may partially or completely misaligned. The inlet/outlet bores may be at different angles relative to the main axis of the turbulence chamber, increasing contact with surfaces during transit. The turbulence chamber may comprise one or more contact piece(s) or other flow-disrupting features. In some examples, the turbulence chamber, and/or the inlet/outlet bores, may have changing diameters or other changing dimensions, for example an inlet or outlet bore than increases or decreased in diameter size as materials travel through.

In certain embodiments, the length to aperture ratio of the inlet and out bores are from about 5 to about 50 or from about 10 to about 40. In some examples, the aperture of the inlet nozzle is about 0.05 mm to about 1 mm, or about 0.25 to 0.75 mm, or about 0.1 to about 0.5 mm, or about 0.2 to 0.4 mm. In some examples, the aperture of the inlet nozzle is about 0.05 mm or more, or about 0.1 mm or more, or about 0.2 mm or more, or about 0.5 mm or more.

In certain embodiments, the outlet nozzle comprises an aperture, wherein the aperture of the outlet nozzle is about 0.05 mm to about 1.5 mm, or about 0.25 to 2.0 mm, or about 0.1 mm to about 1.0 mm, or about 0.3 to 0.6 mm. In some examples, the aperture of the outlet nozzle is about 0.05 mm or more, or about 0.1 mm or more, or about 0.2 mm or more, or about 0.3 mm or more. In some examples, the bore aperture of the inlet nozzle is smaller than the bore aperture of the outlet nozzle, while in other embodiments they are equal. In some examples of the process, the bores of the inlet nozzles and the outlet nozzles are axially spaced apart relative to one another.

In some aspects of the disclosure the liquid dispersion prepared by the process is an aqueous solution. In some examples, liquid dispersion comprises an aqueous solution of one or more fat soluble vitamins or derivative(s) thereof, and one or more matrix materials. In certain embodiments, the fat-soluble vitamin comprises Vitamin A, Vitamin E, Vitamin K, Vitamin D, any derivative of these vitamins, or combination thereof. Example derivative materials include esters. Specific example derivative materials include vitamin E acetate (DL-α-Tocopheryl acetate), vitamin A acetate, and vitamin A palmitate. Vitamins or their derivative may be used in pure form, or may be provided in a suitable diluent such as a fat or oil (e.g. soybean oil).

The one or more matrix materials may include or consist of a polysaccharide or a modified polysaccharide like a modified starch with esters or other hydrophilic and/or hydrophobic moieties added to enhance emulsification properties. For example, a starch may be treated with cyclic dicarboxylic acid anhydrides such as succinic anhydrides. A specific example matrix material is starch sodium octenyl succinate. In certain examples of the process, the matrix material consists of or comprises a lignosulfonate, starch hydrolysate, starch, or modified food starch, or combinations thereof. In some examples the liquid dispersion further comprises inorganic nano-and/or microparticles, preferably wherein the inorganic nano-and/or micro-particles comprise, consist essentially of, or consist of silica. Silica or other additives may be present to assist with flow after drying.

In some examples of the process, the process further comprises combining the liquid dispersion with one or more liquids to provide a liquid beverage. Beverages that may be enhanced with a dispersion obtained via a process of this disclosure include carbonated beverages such as flavored seltzer waters, soft drinks or mineral drinks, as well as non-carbonated juices, punches and concentrated forms of these beverages, such as fruit juices. Example beverages may include fruit flavors such as grape, pear, passion fruit, pineapple, banana or banana puree, apricot, orange, lemon, grapefruit, apple, cranberry, tomato, mango, papaya, lime, tangerine, cherry, raspberry, carrot and mixtures thereof.

In some examples, the process includes drying the liquid dispersion to provide a powder. This may be performed, for example, by spray-drying, freeze drying, or other drying techniques.

As one example, a liquid dispersion may be dried to provide a powder comprising a fat soluble vitamin, such as vitamin E. Example compositional values (weight percent values) for the pre-dispersion discussed above may also apply to the dried powder. As a particular powder example, a dried power prepared from a liquid dispersion may include about fat soluble vitamin and a modified polysaccharide, which powder composition comprises particles of a fat-soluble vitamin, having an average particle size of about 75 to about 125 nanometers (nm) in diameter, or about 125 nm or less, or about 50 to 150 nm. Preferably, the average particle size is about 125 nm or less, or about 120 nm or less, or about 115 nm or less. In some examples, the average particle size of the dispersed phase is sufficiently small that, when later mixed with water, a visibly clear solution is provided. In some examples, the powder may comprise about 50% or more matrix material(s) (such as starch sodium octenyl succinate), or about 75% or more, or about 85% or more, or about 50-90%, or about 60-80% matrix material(s), by weight. In certain embodiments, the powder may comprise about 5% or more fat soluble vitamin(s) or derivative(s) thereof (such as DL-α-Tocopheryl acetate), or about 7% or more, or about 10% or more, or about 20% or more, or about 5-40%, about 5-30%, or about 5-25%, or about 5-40%, by weight. In various embodiments, the powder may comprise about 1% or less of a flow aid (such as silicon dioxide i.e. silica), or about 0.5% or less, or about 0.25% or less, or about 0.1% or less, by weight.

Particle size of the dried powder may be determined by light scattering technique using an instrument such as Coulter Beckmann Delta Nano S, which provides a hydrodynamic diameter. This method is known in the art and described in various references (for example Particle size Distribution, ACS Symposium Series 332, Ed. T. Provder, American Chemical Society, Washington, DC; 1987). Thus, a powder composition of this invention contains particles consisting of the fat soluble vitamin with an average droplet size of about 125 nm or less, or about 80 to 150 nm in diameter by the technique of light scattering.

In certain embodiments, the process further comprises combining the powder with one or more liquids (e.g. an already prepared beverage) to provide a liquid beverage. Example beverages may be obtained by adding to a beverage a powder composition prepared by a process of this disclosure, and mixing, agitating, shaking, and/or stirring until the powder is no longer visible (given the low average particle size). Beverages that may be enhanced with powders prepared from a dispersion obtained via a process of this disclosure include carbonated beverages such as flavored seltzer waters, soft drinks or mineral drinks, as well as non-carbonated juices, punches and concentrated forms of these beverages, such as fruit juices. Example beverages may include fruit flavors such as grape, pear, passion fruit, pineapple, banana or banana puree, apricot, orange, lemon, grapefruit, apple, cranberry, tomato, mango, papaya, lime, tangerine, cherry, raspberry, carrot and mixtures thereof.

### EXAMPLES

In an example of the inventive process, a pre-emulsion of DL-α-Tocopheryl acetate (8% by weight), deionized water (53% by weight) and modified food starch (39% by weight) was prepared. Deionized water was placed in a kettle equipped with a stirrer and warmed to 70° C. The modified food starch was dissolved in the water and stirred to allow degassing of the solution. The tocopherol was added under stirring in the kettle and homogenized with a high pressure homogenizer at a pressure of 200 bar, where the mixture was circulated two times to prepare the pre-emulsion.

The pre-emulsion was then treated to prepare an emulsion dispersion. The pre-emulsion may pass filters with a mesh size of 120 μm before entering the turbulence chamber. The emulsion than passed bores with cylindrical shape and a diameter of 0.25 mm to enter the turbulence chamber and left the turbulence chamber through bores with cylindrical shape and a diameter of 0.4 mm. The emulsion was homogenized three times in circulation at 700 bar using a turbulence chamber with a bore length of about 7 mm, which can provide throughput of about 4500 to about 6000 kg/h therefore having a residence time in the chamber between about 1.94×10⁻⁸ and about 2.60×10⁻⁸. The emulsion was cooled down to 20° C. to stabilize the emulsion directly after the emulsification process. The particle size was determined by means of dynamic light scattering and an average particle size distribution of 110 μm was achieved.

These materials, systems and process descriptions are merely examples. In certain embodiments, the materials include additional combinations and/or substitutions of some or all of the components described above. Moreover, additional and alternative suitable variations, forms and components for the materials will be recognized by those skilled in the art given the benefit of this disclosure. Finally, any of the features discussed in the example embodiments of the processes and/or systems may be features of embodiments of the materials (or components thereof), and vice versa.

1. A process comprising the steps of:
providing a pre-dispersion into a fluid chamber of a mixing device, the pre-dispersion comprising a liquid phase and an oily phase;
optionally, directing the pre-dispersion from the fluid chamber through one or more filtration elements which capture at least some solid particles from the pre-dispersion;
pumping the pre-dispersion one or more times into a turbulence chamber through an inlet nozzle in fluid communication therewith, through the turbulence chamber, and out of the turbulence chamber through an outlet nozzle in fluid communication therewith, to complete one or more passes through the inlet nozzle, turbulence chamber, and outlet nozzle, wherein a residence time of the pre-dispersion in the turbulence chamber for each of the one or more passes through the turbulence chamber is less than 10⁻⁶ seconds; and
collecting a liquid dispersion formed from the pre-dispersion during the one or more passes through the inlet nozzle, turbulence chamber, and outlet nozzle, wherein a dispersed phase of the liquid dispersion comprises an average particle size of 50 nm to 220 nm in diameter, preferably 70 to 140 nm, and more preferably 80 to 120 nm.

2. The process of claim 1, wherein the liquid dispersion has a turbidity of 50 Nephelometric Turbidity Units (NTU) or less, preferably 30 Nephelometric Turbidity (NTU) Units or less.

3. The process of claim 1, wherein the pre-dispersion is pumped in a turbulence chamber, when inside the turbulence chamber during the one or more passes through the inlet nozzle, turbulence chamber, and outlet nozzle, a temperature of the pre-dispersion is 20° C. to 250° C., preferably 40° C. to 80° C., and a pressure of 100 bar to 3,000 bar, preferably 600 bar to 1,400 bar is used.

4. The process of claim 1, wherein a pressure of the pre-dispersion before the turbulence chamber is 600 bar or more, or about 700 bar or more.

5. The process of claim 1, wherein the pre-dispersion has four or fewer passes through the inlet nozzle, turbulence chamber, and outlet nozzle before yielding the liquid dispersion, preferably three or fewer passes through the inlet nozzle, turbulence chamber, and outlet nozzle before yielding the liquid dispersion, and more preferably two or fewer passes through the inlet nozzle, turbulence chamber, and outlet nozzle before yielding the liquid dispersion.

6. The process of claim 1, wherein the oily phase of the pre-dispersion has an average particle size of 200 nm to 5000 nm, preferably 700 nm to 1500 nm.

7. The process of claim 1, wherein the process further comprises generating the pre-dispersion through the application of one of more impact forces, shear forces, cavitation forces, or a combination thereof on a dispersion precursor, e.g. through the use of a rotor stator system or a high pressure homogenizer.

8. The process of claim 1, wherein the residence time of the pre-dispersion during each pass through the turbulence chamber is between 10⁻⁹ and 10⁻⁶ seconds, preferably between 10⁻⁸ and 10⁻⁶ seconds, and more preferably between 1×10⁻⁸ and 5×10⁻⁸ seconds.

9. The process of claim 1, wherein the inlet nozzle comprises an inlet bore, and wherein the inlet bore comprises an aperture diameter of 0.05 mm to 0.5 mm.

10. The process of claim 1, wherein the outlet nozzle comprises an outlet bore, and wherein the outlet bore comprises an aperture diameter of 0.05 mm to 1.5 mm.

11. The process of claim 1, wherein the inlet bore aperture diameter is smaller than the outlet bore aperture diameter.

12. The process of claim 1, wherein the average particle size distribution of the dispersed phase of the liquid dispersion is 50 nm to 200 nm, preferably 70 nm to 120 nm.

13. The process of claim 1, wherein the inlet bore and outlet bore are independently round, rectangular or elliptical.

14. The process of claim 1, wherein the inlet bore and the outlet bore are axially spaced apart relative to one another.

15. The process of claim 1, wherein the liquid dispersion comprises an aqueous solution of a fat soluble vitamin and a matrix material.

16. The process of claim 1, wherein the one or more filtration elements are included before the turbulence chamber with at least one filtration element comprising pores with a pore size of 50 μm to 200 μm, preferably 80 μm to 150 μm or/and filter the aqueous solution of the matrix before preparation of the pre-dispersion with at least one filtration element comprising pores with a pore size of 50 μm to 200 μm, preferably 80 μm to 150 μm.

17. The process of claim 16, wherein the fat-soluble vitamin comprises Vitamin A, Vitamin E, Vitamin K, Vitamin D, or any derivative or combination thereof.

18. The process of claim 1, wherein the matrix material comprises a lignosulfonate, starch hydrolysate, starch, or modified food starch, or a combination thereof.

19. The process of claim 1, wherein the inlet nozzles and outlet nozzles each comprise sapphire, diamond, Stainless Steel, ceramic, silicon carbide, tungsten carbide, or zirconium oxide, or a combination thereof.

20. The process of claim 1, further comprising drying the liquid dispersion to provide a powder.

21. The process of claim 20, further comprising combining the powder with one or more liquids to provide a liquid beverage.

22. The process of claim 1, further comprising combining the liquid dispersion with one or more liquids to provide a liquid beverage.
